(19) United States
(12) Patent Application Publication
(10) Pub. No.: US 2009/0066151 A1
(43) Pub. Date: Mar. 12, 2009

(54) ADAPTABLE WHEEL ASSEMBLY

(76) Inventor: Diko Sulahian, Sante Fe Springs, CA (US)

Correspondence Address: BERENATO, WHITE & STAVISH, LLC, 6550 ROCK SPRING DRIVE, SUITE 240, BETHESDA, MD, 20817, US

(21) Appl. No.: 11/850,783

(22) Filed: Sep. 6, 2007

(51) Int. Cl. B60B 7/10

(52) U.S. Cl. 301/37.34

(57) ABSTRACT

An adaptable wheel assembly, comprising a main wheel body and a modified center cap assembly affixed to the main wheel body via at least one of a first fastening system provided adjacent a central aperture of the wheel and a second fastening system provided adjacent a rim of the wheel radially outside the first fastening system. The modified center cap assembly includes a central cap portion and an extended spoke portion extending radially from the central cap portion toward the rim portion. The modified center cap assembly may be interchangeably disposed on said main wheel body with an additional modified center cap assembly so that a user may customize and update the style and look of a wheel at a reduced expense. The center cap according to the present invention can simulate the spoke of a conventional wheel.

### BACKGROUND OF THE INVENTION

1. Field of the Invention

The present invention pertains generally to custom wheel and more particularly to an adaptable custom wheel that may be altered and updated by affixing a covering member to a blank wheel body.

### BACKGROUND OF THE INVENTION

Automobiles have become the primary means of transportation for many people in this day and age. In addition to providing transportation, automobiles have also become a visible symbol of what type of person someone is. Some wealthy people perceive expensive automobiles as a status symbol, while a rugged individualist will often drive a sport-utility type vehicle. Other people like to express themselves by painting their automobiles bold colors, or by decorating their automobiles with a variety of custom, personalized items.

As a result of the high number of people who customize their automobiles, a large market has been created which caters exclusively to after-market automobile products. With new technology in metal production, one of the most popular items used to customize or up-grade an automobile is the wheel.

The appearance of an automobile with these custom wheels, when compared to an automobile with standard wheels, or even hubcaps, is substantially noticeable. For people who want the ultimate in high-quality and luxury, chrome-plated versions of standard alloy wheels are the wheels of choice, many luxury cars come either with chrome-plated wheels standard, or as an option. However, many have to purchase the custom wheels from an aftermarket company. Regardless of how a person may acquire chrome-plated wheels they can often be very expensive.

Additionally, purchasers of these expensive custom wheels must choose a single style and look or later purchase a second set of custom wheels.

It is known to provide snap-on wheel covers. Many types of wheel covers have been used to provide attractive designs and the currently popular types of wheels. For example, considerable effort has been made to simulate a cast aluminum rim by the use of a shielding disc with a cover that has individual sections such as spokes. Many other wheel covers have the capability of displaying indicia and designs that include symmetrical design arrays as well as decorative designs using irregular shaped voids.

However, these conventional wheel covers are typically not durable enough o withstand the rigors of everyday use and lack the superior quality of true custom wheel.

The need exists for a system that provides custom wheels that may be altered and updated without the need to purchase an entirely new set of wheels.

### SUMMARY OF THE INVENTION

An adaptable wheel assembly comprises a main wheel body and a modified center cap assembly affixed to the main wheel body via at least one of a first fastening system provided adjacent a central aperture of the wheel and a second fastening system provided adjacent a rim of the wheel radially outside the first fastening system. The modified center cap assembly includes a central cap portion and an extended spoke portion extending radially from the central cap portion toward the rim portion. The modified center cap assembly may be interchangeably disposed on said main wheel body with an additional modified center cap assembly so that a user may customize and update the style and look of a wheel at a reduced expense.

The center cap according to the present invention can simulate the spoke of a conventional wheel.

Therefore, the present invention provides an adaptable custom wheel with a face or spoke members that may be altered by the user to be changed and updated.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a side view of a convention wheel assembly.

FIG. 2 is a top view of the conventional wheel shown in FIG. 1.

FIG. 3 is a perspective view of the main wheel body or blank wheel according to the present invention.

FIG. 4 is a perspective view of the main wheel body of FIG. 3 with the modified center cap and extended spokes mounted thereto.

FIG. 5 illustrates the modified center cap and extended spokes according to one embodiment of the present invention.

### DETAILED DESCRIPTION OF THE PREFERRED EMBODIMENT

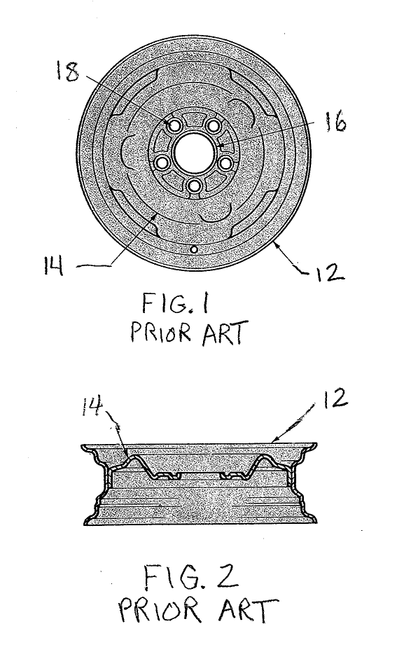

As shown in FIGS. 1 and 2, a standard wheel consists of a rim 12 which is the outer lip that that contacts the tire bead, and the spider 14 or center section that bolts to the vehicle hub (not shown) through a pilot bore 16. Lug bolt holes 18 are provided around the pilot bore 16 at a certain bolt circle diameter. Typically, a safety rim has a small ridge 19 that holds the tire beads on the rim during a tire blow-out or flat. There is also provided a standard aperture 17 for the known valve stem (not shown).

It is known to provide wheels (e.g., custom alloy wheels) with a stylized spider section and a center cap (not shown) at the pilot bore 16 to cover the pilot bore 16 with an ornamental appearance or a company unique logo. The conventional center cap is affixed to the wheel via a snap-fit or friction-fit arrangement or via a separate set screw that affixes the center cap to the wheel. Other methods of affixing the center cap to the wheel or hub are envisioned by this invention and will be encompassed by this invention.

While FIGS. 1 and 2 show a conventional one-piece wheel assembly, the present invention as described below may be applied to any style of wheel including, but not limited to, a two-piece or three-piece wheel assembly. The invention is equally applicable to any manufacturing method, i.e., forged, cast, rolled, etc.

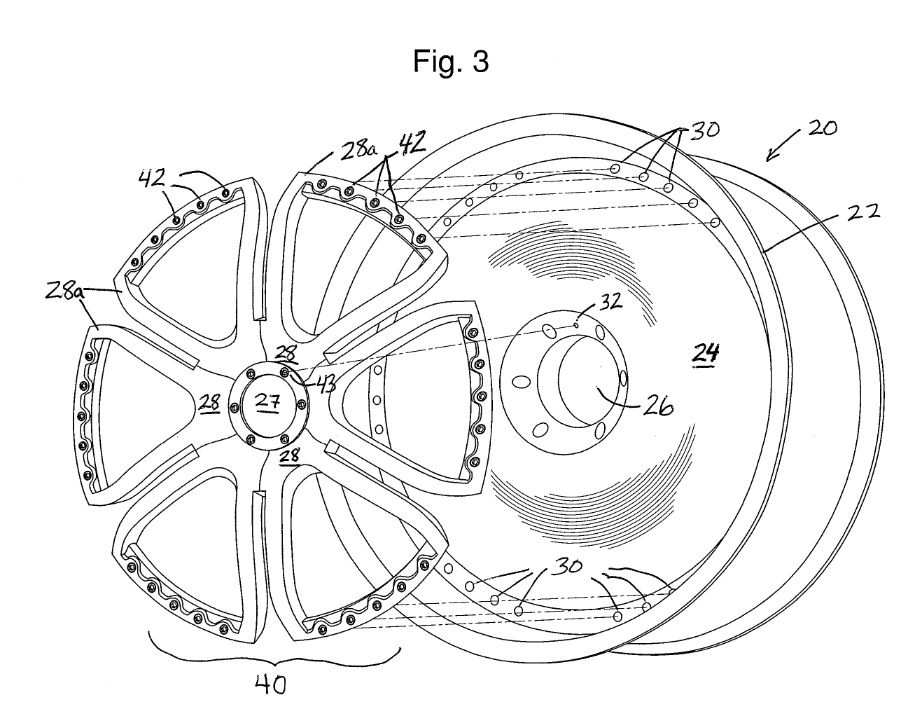

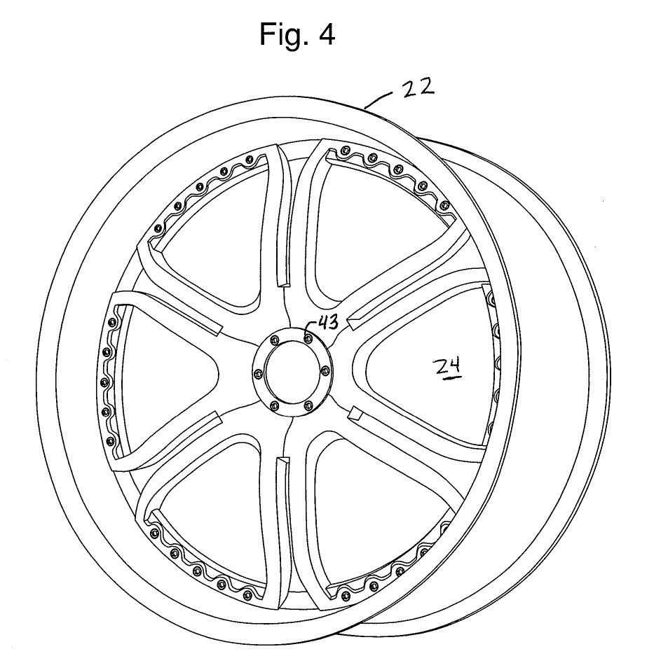

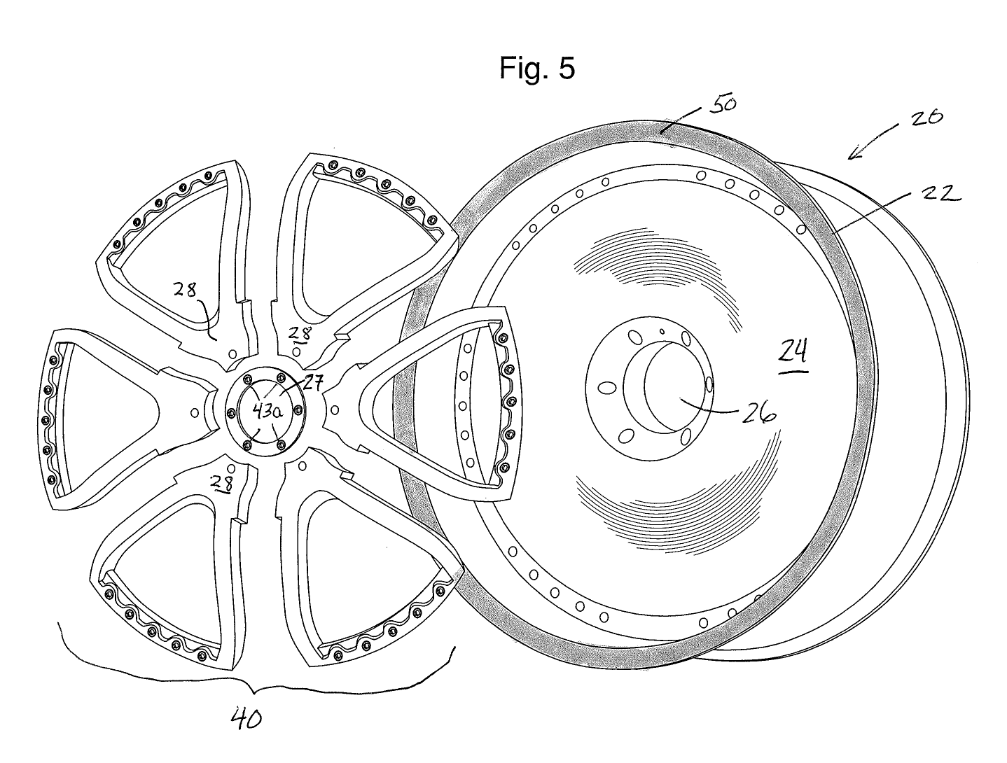

With reference to FIGS. 3 and 4, the invention will be described in conjunction with the preferred embodiment, however, the specific structure and layout of these figures is not intended to limit the scope of the present invention. As shown in FIG. 3, a blank wheel (main wheel body) 20 is illustrated having the conventional rim 22, spider, 24 and pilot bore (central bore) 26.

In accordance with this invention, a modified center cap 27 is provided that includes extended spokes 28. The modified center cap 27 is fixed to the pilot bore 26 in the manner known with traditional center caps. In addition, the extended spokes 28 extend outward to the mounting holes 30 proved at the periphery of the wheel where the spider meets the rim. The distal ends 28a of the extended spokes 28 have fastening devices that mate with corresponding fasting devices on the main wheel body 20 to affix the modified center cap 27 to the wheel.

In the preferred embodiment, a first series of mounting holes 30 are disposed about the outer periphery of the wheel 20 adjacent the rim 22. These holes 30 are disposed in the manner of traditional rivets 42 known in the art. Bolts or rivets 42 serve to secure the extended spokes 28 to the wheel. Of course, other fastening systems may be employed to secure the distal ends 28a of the extended spokes 28 to the wheel 20, including but not limited to a snap-fit system, a friction fit system, adhesive, etc. This is defined herein as the first mounting system of this invention.

Additionally, at least one inner mounting (e.g., bolt, screw or rivet) hole 32 may be provided in the center cap 27 to secure the middle of the center cap 27 in place via fastener 43. Of course, the middle portion of the modified center cap 27 may be secured to the wheel in other known manners of securing a traditional center cap; e.g., snap-it, friction fit, screw, bolt, rivet, etc. This is defined herein as the second mounting system of this invention.

In accord with this invention there is provided at least one but preferably a series of different modified center cap members or modified center caps 27 defining wheel face assemblies 40 that are selectively mounted to the main wheel body 20 through at least one of the first and second mounting systems 30, 32. With a plurality of modified center cap members 27, a user may change or interchange these different cap members 27 to change and update these style and look of the main wheel body 20.

In an alternate embodiment, the cap member 40 is bolted to the wheel 20 only at the rim via the first mounting system; e.g., the series of mounting holes 30 and fasteners 42. Here, the second mounting system 32 may be eliminated from the modified cap member 27.

In a second alternate embodiment, the cap member 40 is secured to the wheel only at the center cap 27 via the second mounting system; e.g. at least one mounting hole 32 and associated fastener. Here, the first mounting system; e.g., the series of mounting holes 30, may be eliminated from the modified cap member 27.

In a further alternate embodiment, the center cap 27 and extended spokes 28 are formed as different structural parts that are fastened together and secured in place via the first mounting system; e.g., series of mounting holes 30 and fasteners 42, as well as the second mounting system; e.g., fasteners 43 or other means, provided at the center cap 27.

In the embodiment illustrated herein, the main wheel body or blank wheel 20 is formed as a solid body with a solid spider 24. It will be understood by those of skill in the art that the main wheel body 20 may be formed with some type of spokes or apertures or other ornamentation known in the art.

The invention thus provides a system whereby custom wheels may be altered and updated without the need to purchase an entirely new set of wheels. This invention reduces the cost to change the style of a wheel. Further, the invention is environmentally friendly because it reduces the number of wheels that are manufactured and/or the number of wheels a user must discard.

While the invention has been described in complete detail and pictorially shown in the accompanying drawings, it is not to be limited to such details, since many changes and modifications may be made to the invention without departing from the spirit and scope thereof. Hence, it is described to cover any and all modifications and forms which may come within the language and scope of the appended claims.

1. An adaptable wheel assembly, comprising:
a main wheel body including a rim portion and a spider portion, said spider portion including a central aperture;
a modified center cap assembly affixed to said main wheel body via at least one of a first fastening system provided adjacent said central aperture and a second fastening system provided adjacent said rim and radially outside said first fastening system, said modified center cap assembly including a central cap portion and an extended spoke portion extending radially from said central cap portion toward said rim portion.

2. The adaptable wheel assembly according to claim 1, wherein said modified center cap assembly is affixed to said main wheel body by said first fastening members provided at said central aperture.

3. The adaptable wheel assembly according to claim 1, wherein said modified center cap assembly is affixed to said main wheel body by said second fastening members provided adjacent said rim.

4. The adaptable wheel assembly according to claim 1, wherein said modified center cap assembly is affixed to said main wheel body by both said first fastening members provided at said central aperture and said second fastening members provided adjacent said rim.

5. The adaptable wheel assembly according to claim 1, wherein said modified center cap assembly may be interchangeably disposed on said main wheel body with an additional modified center cap assembly.

6. The adaptable wheel assembly according to claim 1, wherein said extended spoke portion is an ornamental assembly design to enhance the appearance of an outer face of the main wheel body.

7. The adaptable wheel assembly according to claim 1, wherein said center cap assembly is a unitary homogeneously formed body.

8. The adaptable wheel assembly according to claim 1, wherein said center cap portion is formed separately from said extended spoke portion.

9. The adaptable wheel assembly according to claim 1, wherein said second fastening system comprises at least one fastener passing through a distal end of said extended spoke portion and into an aperture provided in said main wheel body

10. The adaptable wheel assembly according to claim 1, wherein said second fastening system comprises a plurality of fasteners passing through a distal end of said extended spoke portion and into respective apertures provided in said main wheel body.

11. The adaptable wheel assembly according to claim 10, wherein said plurality of fasteners is disposed around a periphery of said main wheel body.

12. The adaptable wheel assembly according to claim 1, wherein said first fastening system comprises a friction fit assembly interlocking said center cap portion to said main wheel body.

13. The adaptable wheel assembly according to claim 1, wherein said first fastening system comprises at least one fastener passing through said center cap portion and into said main wheel body to interlock said center cap portion to said main wheel body.

14. The adaptable wheel assembly according to claim 1, wherein said extended spoke portion extends from said center cap portion to said rim.

15. An adaptable wheel assembly, comprising:
a main wheel body including a rim portion and a spider portion, said spider portion including a central aperture;
a modified center cap assembly affixed to said main wheel body via a first fastening system provided adjacent said central aperture and a second fastening system provided adjacent said rim and radially outside said first fastening system, said modified center cap assembly including a central cap portion and an extended spoke portion extending radially from said central cap portion to said rim portion to thereby define a spoke configuration for the adaptable wheel assembly that may be selectively changed by a user.

16. The adaptable wheel assembly according to claim 15, wherein said second fastening system comprises a plurality of fasteners passing through a distal end of said extended spoke portion and into respective apertures provided in a periphery of said main wheel body.

17. The adaptable wheel assembly according to claim 15, wherein said first fastening system comprises a friction fit assembly interlocking said center cap portion to said main wheel body.

18. The adaptable wheel assembly according to claim 15, wherein said first fastening system comprises at least one fastener passing through said center cap portion and into said main wheel body to interlock said center cap portion to said main wheel body.

19. A center cap for a wheel, comprising:
a central cap portion adapted to fit into a pilot bore form on a wheel, and
extended spokes disposed around a periphery of said central cap portion and extending radially from said central cap portion to simulate spokes of a wheel.

20. The center cap according to claim 19, wherein said extended spoke include means for fastening said extended spoke to said wheel.
